(19) United States
(12) Patent Application Publication
(10) Pub. No.: US 2015/0204308 A1
(43) Pub. Date: Jul. 23, 2015

(54) BRAKE SYSTEM FOR A WIND TURBINE GENERATOR

(71) Applicant: SIEMENS AKTIENGESELLSCHAFT, Munchen (DE)

(72) Inventors: Daniel Kai JENSEN, Horsens (DK); Rune NIELSEN, Ikast (DK); Jens Anton Agerskov VENG, Ikast (DK)

(21) Appl. No.: 14/591,994

(22) Filed: Jan. 8, 2015

(30) Foreign Application Priority Data
Jan. 20, 2014 (EP) 14151794.6

(51) Int. Cl. F03D 7/02; F16D 63/00; F03D 9/00

(52) U.S. Cl. CPC F03D 7/0248; F03D 9/002; F16D 63/006

(57) ABSTRACT

A component for a brake system for a wind turbine generator is provided. The generator including a stator assembly, a rotor assembly and a rotation axis, wherein the rotor assembly includes an outer portion which is located radially outward of the stator assembly is provided. The component has the shape of a ring and includes a means for connecting it to a flange of the stator assembly. The component further includes a number of radially outwardly protruding portions including a means for connecting the radially outwardly protruding portions to frictional members operatively configured for frictionally engaging at least a portion of a brake disc and/or for connecting the radially outwardly protruding portions to a rotor lock system.

### CROSS-REFERENCE TO RELATED APPLICATIONS

This application claims priority to EP Application No. 14151794.6, having a filing date of Jan. 20, 2014, the entire contents of which are hereby incorporated by reference.

### FIELD OF TECHNOLOGY

The following relates to a component for a brake system for a wind turbine generator, a brake system for a wind turbine generator, for example, a direct drive generator (DD-generator), and a wind turbine. The following further relates to a method for assembling a wind turbine generator.

### BACKGROUND

In principle there are two main types of wind turbines in view of the direct drive configuration of a wind turbine. The first type of a wind turbine is the more classical type of a wind turbine comprising a gearbox arranged between a main shaft and a generator of the wind turbine. The second type of a wind turbine is a gearless type, where the gearbox and the conventional generator are substituted by a multipolar generator, a so-called direct drive or directly driven generator. Such a direct drive generator can be made as a synchronous generator with winded rotor or with permanent magnets attached to the rotor, or it can be designed as an alternative type of a generator. One of the challenges with the direct drive generator is the mechanical brake system. The brake system needs to be located at the slowing rotating axis as no gear box is used. The brake system needs to withstand a large braking moment and large brake discs and callipers are necessary.

An example for a typical brake system consists of three individual mounted brake consoles, as disclosed in EP 2333326 A1. A difficulty with this solution is that the brake consoles are hard to mount and have a limited structural strength. The rotor lock in the previous design works by engaging the brake disc radially. This design has met its structural limit and is difficult to upgrade without having influence on braking area and brake integrity. The system used up to now takes a long time and additional manpower for mounting. Moreover, to mount the system, the mounting personnel has to be in situation which is exhausting.

### SUMMARY

An aspect relates to a brake system for a wind turbine generator, an advantageous brake system for a wind turbine generator, an advantageous wind turbine, and an advantageous method for assembling a wind turbine generator.

Aspects relate to a component for a brake system for a wind turbine generator, a brake system for a wind turbine generator, a wind turbine and a method for assembling a wind turbine generator.

The inventive component for a brake system is applicable for a wind turbine generator. The wind turbine generator comprises a stator assembly, a rotor assembly and a rotation axis. The rotor assembly comprises an outer portion which is located radially outward of the stator assembly (outer rotor configuration). The component has the shape of a ring. The component comprises means, preferably a plurality of holes, for connecting the component to a flange of the stator assembly. The component further comprises a number of, preferably at least three, radially outwardly protruding portions (wings). The radially outwardly protruding portions comprise means, preferably a plurality of holes, for connecting the radially outwardly protruding portions to frictional members operatively configured for frictionally engaging at least a portion of a brake disc and/or for connecting the radially outwardly protruding portions to a rotor lock system.

Preferably the outwardly protruding portions (wings) are made in one piece with the component. In other words, the outwardly protruding portions and the component are no separate components connected with each other. Advantageously, the outwardly protruding portions are equally spaced in circumferential direction of the component.

Furthermore, the component and/or a brake disc, for example, a corresponding ring-shaped brake disc, can be prefabricated away from the generator production line and applicable for different generator types. Then a crane can take the component or the complete brake system and it can be mounted onto the generator line by only adding bolts and/or pins and/or shims to align stator with rotor in the braking system.

The frictional members operatively configured for frictionally engaging at least a portion of a brake disc may be brake callipers.

The inventive component has the advantage that the structural strength of the brake system is increased and the forces acting on frictional members, for instance, the brake callipers, and the forces acting on the rotor lock system can be divided over a larger area. Moreover, a fixed shaft in the generator may have a flange casted on, for example, instead of pads. The component can be mounted on this flange. Brake callipers and/or a rotor lock can easier be mounted onto the outwardly protruding portions than in previously known solutions.

The inventive brake system for a wind turbine generator comprises a previously described component and a brake disc. Generally, the inventive brake system has the same advantages as the previously described component. Preferably the brake disc has the shape of a ring. Advantageously, the brake system comprises a rotor lock system.

Moreover, the brake disc can have the shape of a ring and can comprise means, preferably a plurality of holes, for connecting it to the rotor assembly, preferably by means of a flange. Furthermore, pins may be placed in an interface between a fixed shaft flange and the component and may insure placement accuracy and additional strength in the assembly.

Preferably the brake disc comprises a number of holes or recesses and the brake system comprises a number of rotorlock pins configured for engaging into the holes or recesses. Advantageously, the holes or recesses are equally spaced in circumferential direction of the component or the ring portion of the component.

The inventive brake system can comprise a number of rotorlock pins and at least one plate, for instance, a static plate, configured for supporting the rotorlock pins. For example, a plate can be placed on each side of the brake disc. The rotorlock pins can be engaged through a hole in the brake disc and supported by a plate on each side of the brake disc. This reduces bending of the rotorlock pins. For example, one plate can be located on one side of the brake disc and a second plate can be located on the other side of the brake disc.

The inventive wind turbine generator comprises a stator assembly, a rotor assembly and a rotation axis. The rotor assembly comprises an outer portion which is located radially outward of the stator assembly (outer rotor configuration).

The inventive wind turbine generator further comprises a brake system as previously described. The inventive wind turbine generator has the previously mentioned advantages.

Preferably, the stator assembly comprises a flange and the inventive component is connected to the flange. The generator may be a direct drive generator. The generator has advantageously a nominal power or effective power of at least 1 MW, for instance at least 3 MW.

Moreover, the brake disc may extend radially inward from the outer portion of the rotor assembly to the rotation axis. The rotor assembly may comprise a flange and/or threads in the rotor material. The brake disc may be fastened directly into the rotor assembly or to the flange. Furthermore, the at least one frictional member, for instance, brake calliper, can extend radially outward regarding the rotation axis.

The inventive wind turbine comprises a brake system as previously described and/or a generator as previously described. The wind turbine is preferably a horizontal axis wind turbine. The wind turbine may comprise a generator and/or a hub. The brake system may be connected to the generator and/or to the hub. The inventive wind turbine has the same advantages as the inventive brake system and the inventive generator.

The inventive method for assembling a wind turbine generator relates to a generator comprising a stator assembly, a rotor assembly and a rotation axis, wherein the rotor assembly comprises an outer portion which is located radially outward of the stator assembly. The method comprises the step of connecting an inventive component to the stator assembly, preferably by means of a flange. For this purpose, the stator assembly and/or the component may comprise a flange.

The inventive method is in principle applicable for manufacturing a generator or repairing or rebuilding or converting an existing generator.

The method may further comprise the step of aligning the component connected to the stator assembly with a brake disc. The brake disc may be connected to the rotor assembly by means of a flange. Generally, the outer portion of the rotor assembly may comprise the brake disc.

The method may further comprise the step of placing pins in an interface between a fixed shaft flange and the component. This may ensure placement accuracy and additional strength in the assembly.

Furthermore, the component and/or a brake disc, for example, a corresponding ring-shaped brake disc, can be prefabricated away from the generator production line and applicable for different generator types. Then a crane can take the component or the complete brake system and it can be mounted onto the generator line only adding bolts and/or pins and/or shims to align stator with rotor in the braking system.

Embodiments of the invention are advantageous in that the entire brake system and/or rotorlock system can be completely pre-assembled away from the line. It has only to be figured out which thickness shims are needed to be added during the assembly state of the brake and/or rotorlock system on the rest of the generator. Mounting a component or console ring for brakes and rotorlock on a flange of a fixed shaft is an uncomplicated procedure and with the use of pins it helps easy aligning and centering placement of the rotorlock and brake caliper.

As the lock system may require a plurality of locks, for instance three locks, to be engaged simultaneously, making one piece component or console ring in one machining negates almost entirely the inter alignment between the locks, for instance three locks. One inventive component or console ring can also avoid unexpected wear from calliper pads, as they are placed in the same machined plane. Thereby the system is more cost efficient and more serviceable than previous systems.

### BRIEF DESCRIPTION

Further features, properties and advantages of embodiments of the present invention will become clear from the following description of embodiments in conjunction with the accompanying drawings. The embodiments do not limit the scope of embodiments of the present invention which is determined by the appended claims. All described features are advantageous as separate features or in any combination with each other. Corresponding elements are designated with the same reference numerals.

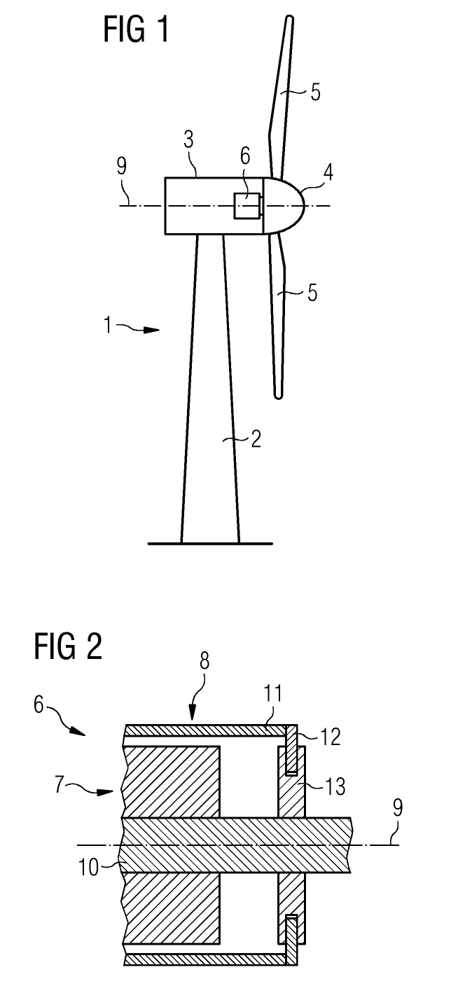

FIG. 1 schematically shows an embodiment of a wind turbine;

FIG. 2 schematically shows part of an embodiment of a generator with an outer rotor configuration in a sectional view;

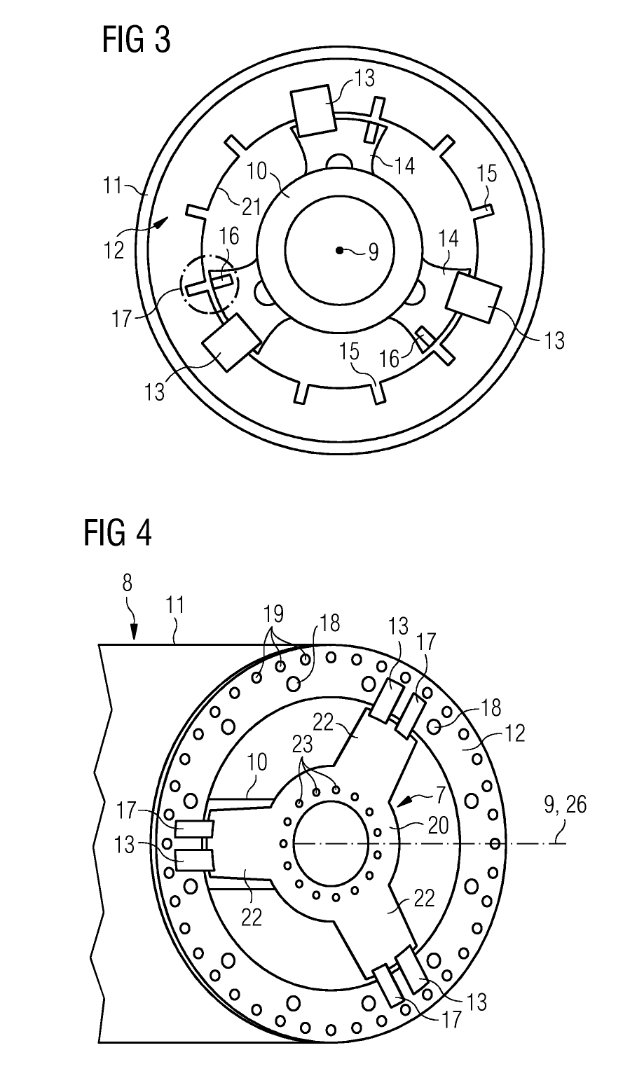

FIG. 3 schematically shows a front view of a known brake system;

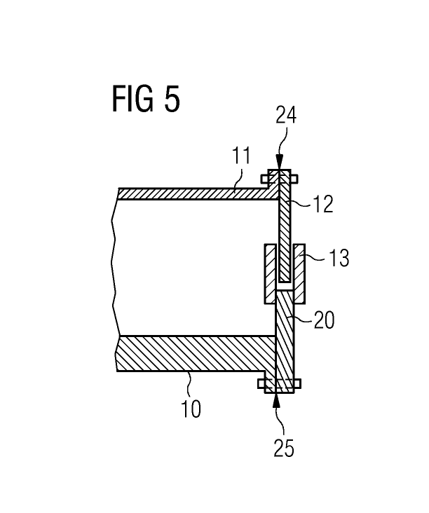

FIG. 4 schematically shows a perspective view of an embodiment of the inventive brake system; and

FIG. 5 schematically shows a sectional view of part of an embodiment of the inventive generator.

### DETAILED DESCRIPTION

FIG. 1 schematically shows a wind turbine 1. The wind turbine 1 comprises a tower 2, a nacelle 3 and a hub 4. The nacelle 3 is located on top of the tower 2. The hub 4 comprises a number of wind turbine blades 5. The hub 4 is mounted to the nacelle 3. Moreover, the hub 4 is pivot-mounted such that it is able to rotate about a rotation axis 9, for example a horizontal rotation axis 9. A generator 6 is located inside the nacelle 3. The wind turbine 1 is a direct drive wind turbine.

FIG. 2 schematically shows part of a generator 6 with an outer rotor configuration in a sectional view. The generator 6 comprises a stator assembly 7 and a rotor assembly 8. The stator assembly 7 comprises a stationary shaft 10 which is located close to the rotation axis 9. The rotor assembly 8 comprises an outer rotor portion 11 which is located radially outward of the stator assembly 7. The rotor assembly 8 further comprises a brake disc 12. The brake disc 12 may be part of the outer rotor portion 11 or it may be connected to the outer rotor portion 11, for example by means of a flange. The brake disc 12 extends radially inward from the outer portion 11 to the rotation axis 9. The outer portion 11 of the rotor assembly 8 and the brake disc 12 are pivot-mounted about the rotation axis 9.

The stator assembly 7 further comprises a frictional member, in the present embodiment a brake calliper system 13. The brake calliper system 13 is operatively configured for frictionally engaging at least a portion of the brake disc 12. The brake calliper system 13 extends radially outward from the stationary shaft 10 to the brake disc 12. The brake calliper system 13 comprises at least one brake calliper on each side of the brake disc 12 in order to enclose the brake disc 12.

FIG. 3 schematically shows a front view of a known brake system of the generator 6. The brake disc 12 comprises an inner surface 21. The inner surface 21 of the brake disc 12 comprises a number of recesses 15. The brake system further comprises a number of central mounted consoles or flanges 14, in the present embodiment three central mounted consoles or flanges 14. The consoles or flanges 14 are individually mounted to the stationary shaft 10. The consoles or flanges 14 are staggered about an angle of 120° regarding the circumference of the stationary shaft 10. Alternatively any other number of the consoles or flanges 14 is possible. Preferably the consoles or flanges 14 are arranged around the circumference of the stationary shaft 10 such that adjacent flanges have an equal distance to each other.

The brake system comprises at least one rotor lock system 17. The rotor lock system 17 comprises at least one piston 16. The piston is located inside the console or flange 14 or is located inside of a lock casing. The lock casing can be connected to the console or flange 14. Alternatively, the brake system can comprise separate consoles or flanges for housing the pistons or for being connected with at least one lock casing of the rotor lock system 17 and separate consoles or flanges 14 being connected with the brake system, especially the brake calliper system 13. The pistons 16 are located such that they are prepared to engage with the recesses 15 in the inner surface 21 of the brake disc 12.

FIG. 4 schematically shows a perspective view of an inventive brake system. The brake system comprises an inventive component 20, which has the shape of a ring. The component 20 comprises means, for example a plurality of holes 23, for connecting it to a flange of the stator assembly 7, for example, by means of bolts, pins or shims. The component can for instance be connected to a flange of the stationary shaft 10.

The component 20 further comprises a central axis 26 and at least three radially outwardly protruding portions (wings) 22. The component 20 and the radially outwardly protruding portions 22 are made in one piece.

The radially outwardly protruding portions 22 may comprise means (not shown in FIG. 4), for example, a plurality of holes, for connecting the radially outwardly protruding portions 22 to frictional members 13 operatively configured for frictionally engaging at least a portion of the brake disc 12 and/or for connecting the radially outwardly protruding portions to a rotor lock system 17.

The protruding portions (wings) 22 are staggered about an angle of 120° regarding the circumference of the component 20. Alternatively, any other number or angle of the protruding portions 22 is possible. Preferably, the protruding portions 22 are arranged around the circumference of the component 20 such that adjacent protruding portions 22 have an equal distance to each other.

The inventive brake system further comprises a brake disc 12. The brake disc 12 may have the shape of a ring. The brake disc 12 comprises a plurality of holes 19 for connecting it to the rotor assembly 8 by means of a flange or threaded holes. The brake disc 12 may further comprise a number of holes 18 or other means for rotorlock pins configured for engaging into the holes.

FIG. 5 schematically shows a sectional view of part of an inventive generator 6. The brake disc 12 is connected to the outer portion 11 of the rotor assembly 8 by means of a flange 24. The stator assembly 7, for example the central shaft 10, comprises a flange 25. The component 20 is connected to the stator assembly 7 by means of the flange 25.

In the context of the inventive method for assembling a wind turbine generator the component 20 is connected to the stator assembly 7, preferably to the stationary shaft 10 by means of the flange 25. The inventive method is applicable for manufacturing a generator or repairing or rebuilding or converting an existing generator.

After connecting the component 20 to the stator assembly 7, the component 20 can be aligned with a brake disc 12. The brake disc 12 may be connected to the rotor assembly 8 by means of the flange 24 or by means of threaded holes/pins in the rotor assembly. Generally, the outer portion 11 of the rotor assembly 8 may comprise the brake disc 12.

The method may further comprise the step of placing pins in an interface between a fixed shaft flange 25 as well as for the rotor assembly 11 and the component 20 (not shown in FIG. 5). This may insure placement accuracy and additional strength in the assembly.

Furthermore, the component 20 and/or a brake disc 12, for example a corresponding ring-shaped brake disc, can be prefabricated away from the generator production line and applicable for different generator types. Then a crane can take the component or the complete brake system and it can be mounted onto the generator line only adding bolts and/or pins and/or shims to align stator with rotor in the braking system.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A component for a brake system for a wind turbine generator, the generator comprising a stator assembly, a rotor assembly, and a rotation axis, wherein the rotor assembly comprises an outer portion which is located radially outward of the stator assembly, wherein the component has a shape of a ring, the component comprising:
a means for connecting the component to a flange of the stator assembly; and
a number of radially outwardly protruding portions comprising a means for connecting the radially outwardly protruding portions to frictional members operatively configured for at least one of frictionally engaging at least a portion of a brake disc, connecting the radially outwardly protruding portions to a rotor lock system, and both frictionally engaging at least a portion of a brake disc and connecting the radially outwardly protruding portions to a rotor lock system.

2. A brake system for a wind turbine generator, further comprising a component as claimed in claim 1, and a brake disc.

3. The brake system as claimed in claim 2, wherein the brake system comprises a rotor lock system.

4. The brake system as claimed in claim 2, wherein the brake disc has a shape of a ring and comprises a means for connecting the brake disc to the rotor assembly.

5. The brake system as claimed in claim 2, wherein the brake disc comprises a number of holes or recesses and the brake system comprises a number of rotorlock pins configured for engaging into the holes or recesses.

6. The brake system as claimed in claim 2, further comprising a number of rotorlock pins and a static plate configured for supporting the rotorlock pins.

7. A wind turbine generator comprising a stator assembly, a rotor assembly and a rotation axis, wherein the rotor assembly comprises an outer portion which is located radially outward of the stator assembly, wherein the wind turbine generator comprises a brake system as claimed in claim 2.

8. The wind turbine generator as claimed in claim 7, wherein the wind turbine generator is a direct drive generator.

9. The wind turbine generator as claimed in claim 7, wherein the brake disc extends radially inward from the outer portion of the rotor assembly to the rotation axis.

10. The wind turbine generator as claimed in claim 7, wherein the stator assembly comprises a flange and the component as claimed in claim 1 is connected to the flange of the stator assembly and/or the rotor assembly comprises a flange and the brake disc is fastened to the flange of the rotor assembly.

11. The wind turbine generator as claimed in claim 7, wherein at least one frictional member extends radially outward regarding the rotation axis.

12. A wind turbine comprising at least one of a brake system as claimed in claim 2, a wind turbine generator as claimed in claim 7, and both the brake system as claimed in claim 2 and the wind turbine generator as claimed in claim 7.

13. A method for assembling a wind turbine generator comprising a stator assembly, a rotor assembly and a rotation axis, wherein the rotor assembly comprises an outer portion which is located radially outward of the stator assembly, the method comprising:
connecting a component as claimed in claim 1 to the stator assembly.

14. The method as claimed in claim 13, further comprising aligning the component connected to the stator assembly with a brake disc.

15. The method as claimed in claim 13, wherein the component is at least one of connected to the stator assembly by means of a flange and/or connecting a brake disc to the rotor assembly by means of a flange.

16. The wind turbine generator as claimed in claim 7, wherein the wind turbine has a nominal power of at least 1 MW.

17. The method as claimed in claim 13, further comprising connecting a brake disc to the rotor assembly by means of a flange.
